(19) United States
(12) Patent Application Publication
(10) Pub. No.: US 2011/0166901 A1
(43) Pub. Date: Jul. 7, 2011

(54) User-Activity Management System

(76) Inventor: Cesar Rodriguez-Matos, Wilmington, NC (US)

(21) Appl. No.: 12/979,754

(22) Filed: Dec. 28, 2010

Related U.S. Application Data
(60) Provisional application No. 61/335,271, filed on Jan. 4, 2010.

(51) Int. Cl. G06Q 10/00; G06F 17/30

(52) U.S. Cl. 705/7.11; 705/1.1; 707/812; 707/E17.005

(57) ABSTRACT

A sales activity management device adapted to monitor, manage, and/or track a plurality of sales activities constituting a sales cycle.

### RELATED APPLICATIONS

This application claims the benefit of U.S. Provisional Application No. 61/335,271 filed on Jan. 4, 2010.

### BACKGROUND OF THE INVENTION

1. Field of the Invention

The present invention relates generally to a user-activity management system, and more specifically, a system comprising a portable device for tracking and storing user-activity for a given observable cycle.

2. Description of the Related Art

At present, the systems and/or methods used for tracking, monitoring and aggregating activity data generally involves the use of “groupware”, or in the area of business sales, “sales automation software”, or the like. These formats allow individuals or teams to input, characterize and generate meaningful reports on the data generated during a sale cycle.

It appears that the available software programs are limited to forecasting probabilities of success for a potential transaction and/or prioritizing potential transactions based on the probabilities of success. Thus, this and similar programs and systems attempt to economize and optimize a salesperson's time and energy on transactions most likely to yield completed transactions and sales commission(s).

As a result of the void that presently exists in this field of endeavor, the present application discloses a device and system that receive, store and characterize data input by the user for a given cycle or window. In the device and system disclosed herein, a device and system are utilized to enhance sales efficiency and productivity based on the data input.

Thus, a need has been demonstrated for a device and system for user-activity management. As such, the present application discloses a device and system by which these and other objects are achieved.

A search of the prior art did not disclose any patents that read directly on the claims of the instant invention; however, the following references were considered related:

U.S. Pat. No. 7,216,087 B2, issued in the name of Thompson et al.;

U.S. Pat. No. 6,763,252 B2, issued in the name of Itazawa;

U.S. Pat. No. 6,311,191 B1, issued in the name of Retallick;

U.S. Pat. No. 7,155,424 B2, issued in the name of Ikezawa et al.;

U.S. Pat. No. 6,820,060 B1, issued in the name of Eisner,

U.S. Pat. No. 7,266,508 B1, issued in the name of Owen et al.;

U.S. Pat. No. 7,225,193 B2, issued in the name of Mets et al.;

U.S. Pat. No. 6,622,116 B2, issued in the name of Skinner et al.;

U.S. Pat. No. 6,631,497 B1, issued in the name of Jamshidi et al.;

U.S. Pat. No. 7,200,389 B2, issued in the name of Date et al.;

U.S. Patent Application no. 2008/0275748 A1, published in the name of John;

U.S. Pat. No. 7,212,987 B2, issued in the name of Swanke et al.; and

U.S. Pat. No. 7,076,499 B2, issued in the name of Powers.

Consequently, a need has been felt for a device and system for user-activity management. This application presents claims and embodiments that fulfill a need or needs not yet satisfied by the devices, inventions and methods previously or presently available. In particular, the claims and embodiments disclosed herein describe a sales activity management device adapted to monitor, manage, and/or track a plurality of sales activities comprising a sales cycle, the sales activity management device is further adapted to input and store the activities in order to provide ratios and percentages calculated from particular combinations of sales activities, wherein the calculated ratios and percentages being retrievable and viewable, wherein the sales activity management device is further adapted for communication with an external device for uploading data from the device to the external device via an appropriate communication interface, and wherein the sales activity management device is operatively coupled with the external device via wireless communication, the sales activity management device of the present invention providing unanticipated and nonobvious combination of features distinguished from the software, devices, inventions and methods preexisting in the art. The applicant is unaware of any software, device, method, disclosure or reference that discloses the features of the claims and embodiments disclosed herein.

### SUMMARY OF THE INVENTION

Briefly described according to one embodiment of the present invention, a sales activity management device adapted to monitor, manage, and/or track a plurality of sales activities comprising a sales cycle. The device may be further adapted to input and store the activities in order to provide ratios and percentages calculated from particular combinations of sales activities, wherein the calculated ratios and percentages being retrievable and viewable. The device may be further adapted for communication with an external device for uploading data from the device to the external device via an appropriate communication interface. The device may be operatively coupled with the external device via wireless communication. The device may be operatively coupled with the external device via a USB connection.

In another embodiment, an activity management device comprises a central processing unit and machine-readable storage medium; machine-readable instructions encoded on the medium for executing instructions for receiving and storing data and inputting at least one event notice; an alarm coordinated with the at least one event notice; a communication interface operatively coupled with an external device for uploading the data from the management device to the external device.

In another embodiment, an activity management system comprises an activity management device comprising; a central processing unit and machine-readable storage medium; machine-readable instructions encoded on the medium for executing instructions for receiving and storing data and inputting at least one event notice; an alarm coordinated with the at least one event notice; a communication interface operatively coupled with an external device for uploading the data from the management device to the external device; and a database remotely stored and populated by the data uploaded from the management device via the external device to the database.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a detailed block diagram of a user-activity management device described herein, according to one embodiment of the present invention;

FIG. 1A is a detailed block diagram of a user-activity management device described herein, according to another embodiment of the present invention;

FIG. 1B is a detailed block diagram of a user-activity management device described herein, according to still another embodiment of the present invention; and

FIGS. 2-8 illustrate results generated from data input into the device or system described herein, in accordance to one embodiment of the present invention.

### DESCRIPTION OF THE PREFERRED EMBODIMENT

### Detailed Description of the Figures

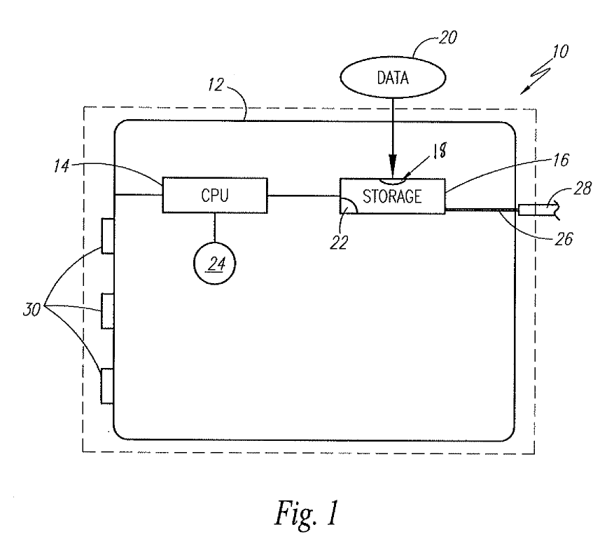

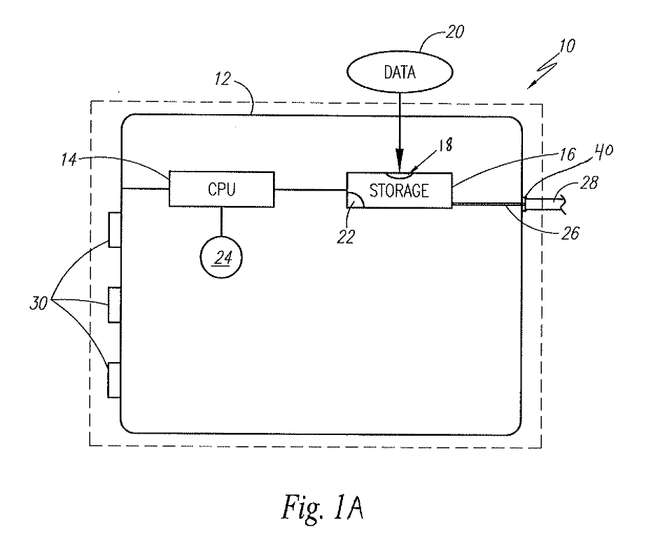

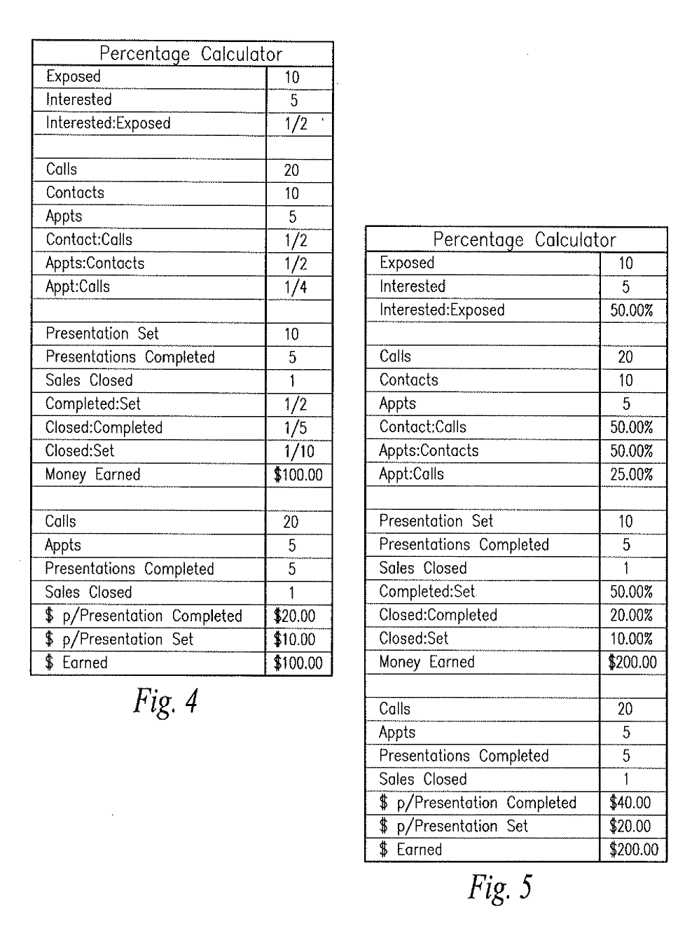

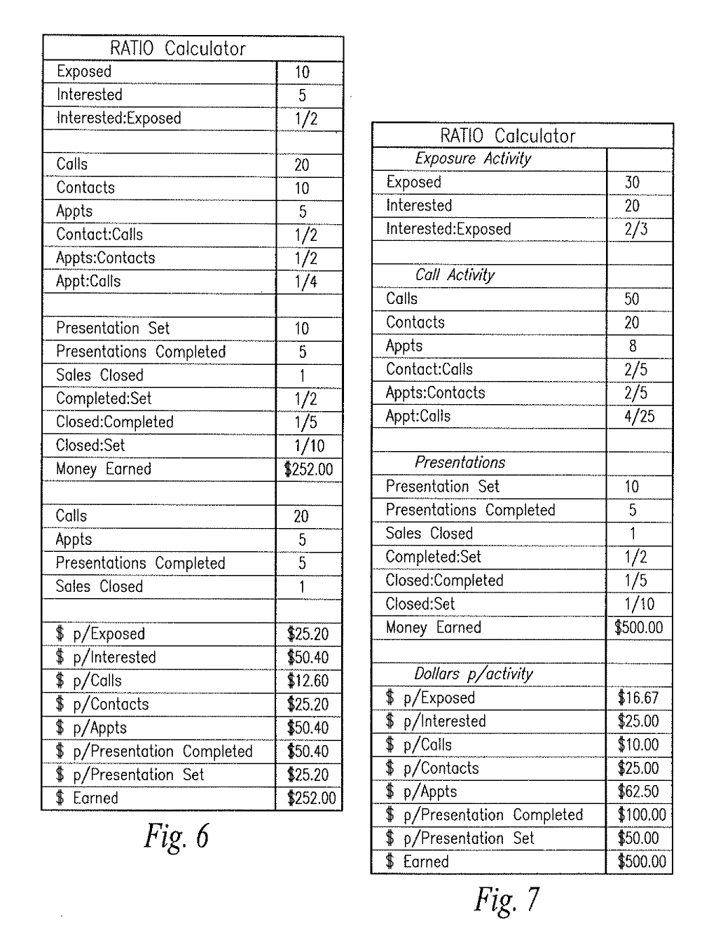

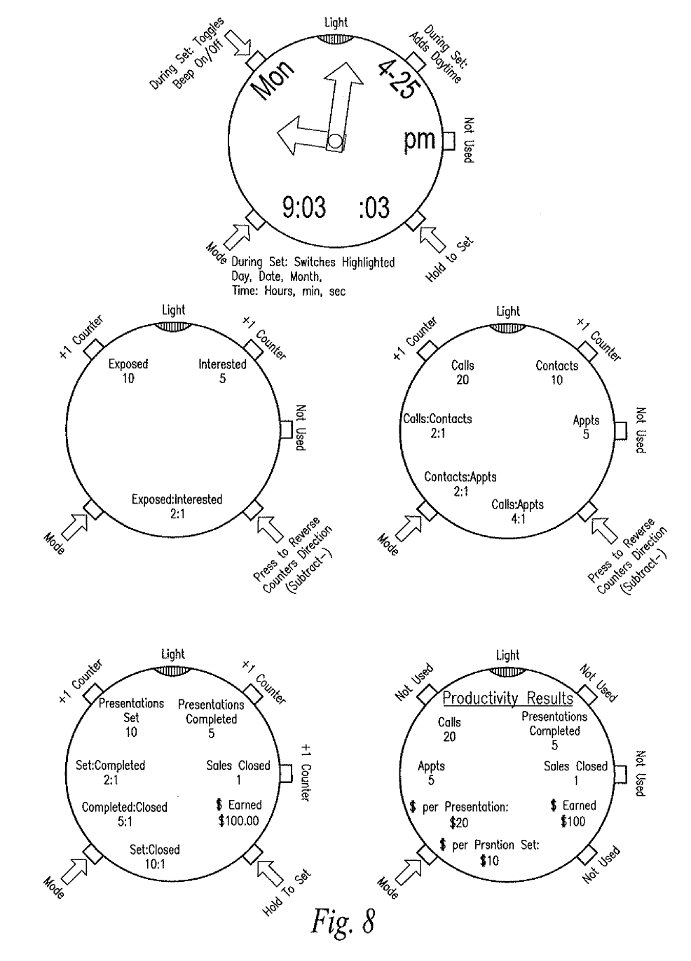

Referring now to FIGS. 1-8, a user-activity management device and system 10 are disclosed. The user-activity management device and system 10, hereinafter referred to as “device 10”, generally comprises a housing 12 having a central processing unit (CPU) 14 and machine-readable storage medium 16. The CPU 14 and storage medium 16 operatively coupled to communicate and facilitate execution of machine-readable instructions 18 encoded on the medium 16 for executing instructions for receiving and storing data 20 and inputting at least one event notice 22. The device 10 may further include an alarm 24 or alarms coordinated with the number of event notices 22 input into the device 10. The device 10 may further include a communication interface 26 operatively coupled with a mobile external device 28 for uploading the data 20 from the management device 10 to the external device 28. External device 28 is envisioned to include an electronic device which includes, but is not limited to the following: wrist-worn electronic device; watch; cellular phone, BlackBerry®, iPhone®, personal digital assistant (PDA), and the like. The device 10 may have one or more depressible buttons 30 for providing quantitative data input onto the device 10.

The housing 12 may be fabricated into one or more forms from a variety of materials. It is envisioned that one embodiment includes a housing 12 bearing similarities to a watch, including hand-held stop watches or wrist watches (having bands for attachment and removal from a user's arm). Thus, the housing 12 may have a face mutually opposed to a back, the face including a multi-function display for indicating information such as time, day, date, as well as activity-driven information, such as sales data (explained in further detail below). In one embodiment, it is envisioned that the face may include a combination of digital and analog displays for conveying information, including redundant time information (such as digital display of time and analog display of time using watch hands, for example). The housing 12 may include one or more means for securing the device 10 to another object, such as a clip for secure placement on a belt or sleeve. The housing 12 may include one or more legs or other similar means for propping the device 10 on a substantially flat surface, such as a table or desk.

The alarm 24 may comprise one or more customizable and coordinated alarm signals, such as vibratory signals, audible signals, visual signals, and/or a combination of two or more of the options listed. Each type of signal may have multiple settings to deliver specific alarms for specific activities or events.

The communication interface 26 may comprise a variety of elements or components known in the art, such as a USB port 40 or other mechanical port for interconnecting the device 10 with an external device 28, such other mechanical port being a network server 50. The network server 50 interconnecting the CPU 14 and data storage medium 16, and external device 28. Thus, a user may insert a USB cable into the respective ports of the management device 10 and the external device 28, and upon interface command, initiate the transfer of information and data 20 from the management device 10 to the external device 28 which may be used to upload the information or data onto network 50 or Internet database, populating the corresponding database cells of medium 16 with information for storage, recall and analysis. In addition, external device 28 may include a secure digital memory card port into which a secure digital memory card (SD Card) is inserted. SD Card comprises information and data transferred thereto from management device 10, wherein external device 28 uploads the information or data stored on SD Card which may be accessed and used by user. Further, it is also envisioned that the interface 26 may comprise a wireless communication connection 29, including such wireless communication systems such as Bluetooth® and similarly enabled or compatible systems, for wirelessly interconnecting the device 10 with the network server 50 and also facilitating the wireless transfer of information or data 20 from the management device 10 or from the network 50 to the external device 28. Further, upon interface command, user may initiate the wireless transfer of information and data 20 from the management device 10 to the external device 28 which may be used to wirelessly upload the information or data onto network 50 or Internet database, wirelessly populating the corresponding database cells of medium 16 with information for storage, recall and analysis.

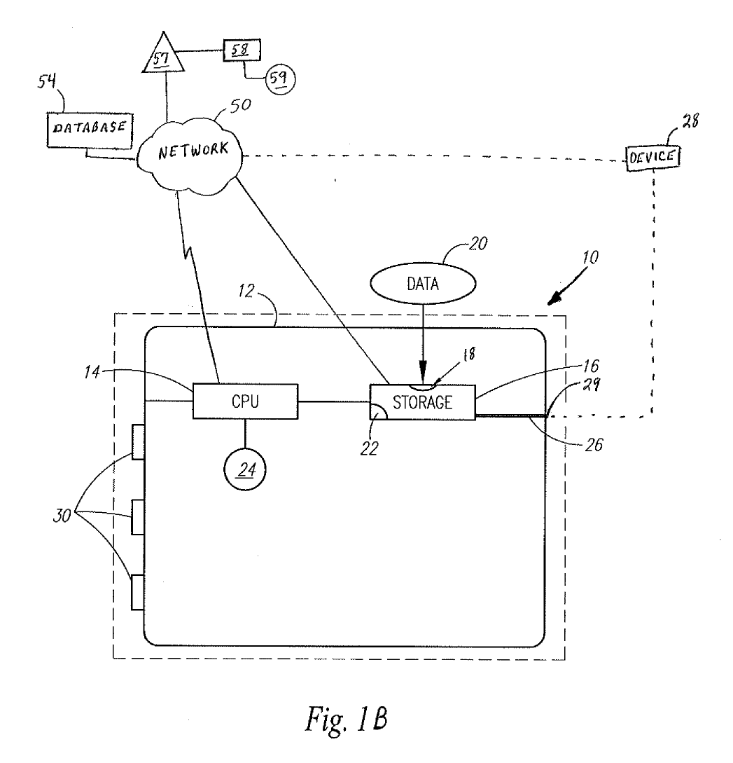

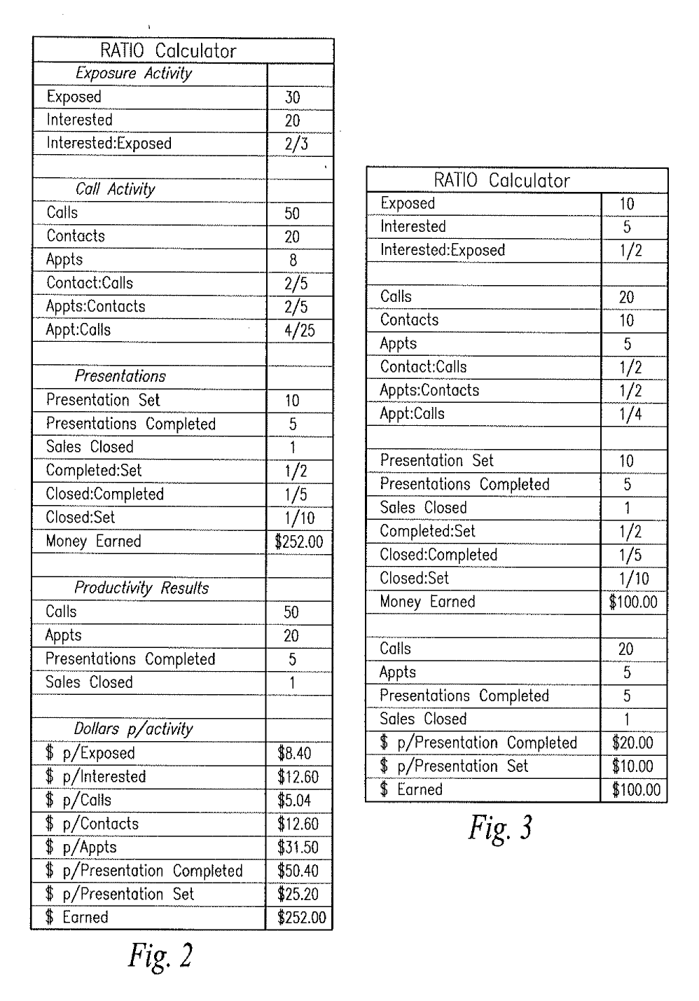

The data 20 may comprise a virtually limitless selection of observable information. By way of example and not a limitation on the disclosure provided herein, in the context of property sales, it may be useful to monitor, manage, and/or track a plurality of sales activities comprising a sales cycle. The device 10 may be further adapted to input and store the activities in order to provide ratios and percentages calculated from particular combinations of sales activities, wherein the calculated ratios and percentages being retrievable and viewable. For sales specific activity, and as presented in FIG. 2 through FIG. 8, the data 20 may include such information generally categorized as “exposure activity”, “contact activity” and “presentation activity”, respectively, though the description is not limited to these categories. In a given cycle, such as a business day (approx. 8-10 hours), “exposure activity” may include activities such as the number of parties exposed to available property and the number of parties interested in available property. “Contact activity” may include activities such as the number of calls placed in reference to available property, the number of actual contacts made, and any appointments resulting from the calls and contacts. “Presentation activity” may include the number of presentations set, the number of presentations completed, and the number of sales closed by the salesperson. Additional sub-data of each represented data may be collected as well, such as demographics of potential actors (marital status, family size, income level, profession, etc.). As represented in the examples provided in FIG. 2 through FIG. 8, the collected data can be sorted and organized, and then characterized to provide percentages and/or ratios, thereby providing meaningful feedback to the user. The user can review the information and determine where the strengths and weaknesses may be, and discern in patterns in behavior of the actors, or emerging issues with specific property available for purchase.

A user may have access to a network 50, such as via an intranet or Internet connection, for transferring/transmitting the information and data 20 from the device or system 10 to a database 54 stored on the network 50. For example, in an Internet-based application, one or more users may have protected access to a customized database 54 stored on a network 50 or website or accessible through other standard file or data transferring means (e.g. FTP). In such Internet-based application, user must provide the appropriate and verified security access information, such as unique user name and password associated therewith. Password verification is achieved using a password module 57 of server or network 50. The password module 57 controls a password manager screen 58 which enables the user to share information, such as data 20, and to import and download images or videos from other websites and services. Manager screen 58 provides user with share/import/download options 59 which include, e.g., sharing information, importing and downloading material from a social network site such as Facebook® and MySpace®. In one example, Facebook® may have an import utility that enables a user to select and import content from Facebook® such as pictures of friends, and pictures posted in image galleries. Importation can also occur from website entities which allow uploading and downloading of information, messages, pictures and multimedia content such as Picassa/Google; Kodak.com, Youtube.com, MSN-Messenger; MySpace®; and Shutterfly.com, using software modules written in order to cooperate with the infrastructures of that particular social network site.

Thus, a user would input a username and password, and clear verification, to access such a customized database 54. It is envisioned that the upload of information from device 10, via external device 28, to database 54 may be permanent or temporary, depending upon the desires of the user(s) or the group. In one embodiment, it is envisioned that the data may be transferred to populate the database 54, and once collected and arranged, may be transmitted back to the device 10 for recall by the user to analyze the information on the spot without necessitating use of a desktop or laptop computer, for example.

In groups of varying size, the database 54 may be manipulated by the various users to enter, characterize and sort the data to analyze the information. Thus, in this manner, the device and system 10 achieve additional versatility and increase the availability of meaningful information that may be imparted to one or more members of the group.

In another embodiment, an activity management system is described, the system comprising an activity management device 10 similar to the device previously described above, and including a central processing unit and at least one machine-readable storage medium having machine-executable instructions for performing activity management. The system may further include machine-readable instructions encoded on the medium (media) for executing instructions for receiving and storing data and inputting at least one event notice. The system may include an alarm coordinated with the at least one event notice. A communication interface is provided and operatively coupled with an external device for uploading the data from the management device to the external device. The system may further include a database remotely stored and populated by the data 20 uploaded from the management device 10 via the external device 28 to the database.

In another embodiment, there are one or more machine-readable executable instructions installed on a processor or within the memory of a machine, including a personal computer, laptop computer or other machine, for performing sales activity management for monitoring, managing, and/or tracking a plurality of sales activities comprising a sales cycle. The method performed or carried out by the machine-readable instructions comprises receiving and storing data and inputting at least one event notice; coordinating an alarm with the at least one event notice; inputting and storing the plurality of sales activities; providing ratios and percentages calculated from particular combinations of sales activities; retrieving and viewing the calculated ratios and percentages; and a communication interface operatively coupled with an external device for uploading the data from the management device to the external device. The data may comprise sales data and/or competition data.

In one embodiment, the one or more machines are operatively coupled with one or more external devices via wireless communication, the one or more devices capable of performing the machine-executable instructions and transmitting information therebetween. In another embodiment, the one or more machines are operatively coupled with one or more external devices via USB connection, the one or more devices capable of performing the machine-executable instructions and transmitting information therebetween.

It is envisioned that a web-based program and system may be utilized to provide remote access to users and members of the program or system. For example, the program or system may be installed on a computer or server 50 with machine-readable executable instructions that may be remotely accessed by one or more users subsequent to the user(s) providing the appropriate and verified security access information, such as a unique user name and password associated therewith. Once the user name and password information are verified, and access to the program(s) or system(s) is granted, the user(s) may explore the site and utilize a number of business-tracking programs that monitor and translate sales data and information into meaningful charts, graphs and other digestible forms of information.

It is envisioned that the web-based program/system, and more particularly the content stored within the program/system, will be user-generated and edited. For example, a user (e.g. an individual or a business providing access to multiple personnel) may utilize a particular template spreadsheet for monitoring a particular activity(ies). If the user(s) save the template spreadsheet to the program/system, the template may be accessed by other members of the website (depending upon tiered-levels of membership). Thus, with multiple users uploading and saving multiple template documents to the site, the program/system may be utilized by the members to develop a working library of documents from which other members may utilize the documents for internalized or business-specific purposes.

In particular, it is envisioned that a user may log onto the program/system and begin inputting various activities, including micro-analytical materials that may help determine various efficiencies or inefficiencies in the business model. The website can convert input activities, such as numerical data, and perform calculations, generate statistics, and monitor time management data, and further translating this information into usable graphs.

It is envisioned that the various embodiments, as separately disclosed, are interchangeable in various aspects, so that elements of one embodiment may be incorporated into one or more of the other embodiments, and that specific positioning of individual elements may necessitate other arrangements not specifically disclosed to accommodate performance requirements or spatial considerations.

It is to be understood that the embodiments and claims are not limited in its application to the details of construction and arrangement of the components set forth in the description and illustrated in the drawings. Rather, the description and the drawings provide examples of the embodiments envisioned, but the claims are limited to the specific embodiments. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions. Furthermore, the purpose of the foregoing Abstract is to enable the U.S. Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way. It is intended that the application is defined by the claims appended hereto.

What is claimed is:

1. A sales activity management device, the sales activity management device is adapted to monitor, manage, and/or track a plurality of sales activities, the plurality of sales activities comprising a sales cycle.

2. The device of claim 1, wherein the sales activity management device is further adapted to input and store the sales activities in order to provide ratios and percentages calculated from particular combinations of the sales activities, wherein the calculated ratios and percentages being retrievable and viewable.

3. The device of claim 1, wherein the sales activity management device is further adapted for communication with an external device for uploading data from the device to the external device via an appropriate communication interface.

4. The device of claim 3, wherein the sales activity management device is operatively coupled with the external device via wireless communication.

5. The device of claim 3, wherein the sales activity management device is operatively coupled with the external device via a USB connection.

6. An activity management device comprising:
a central processing unit and machine-readable storage medium;
machine-readable instructions encoded on the medium for executing instructions for receiving and storing data and inputting at least one event notice;
an alarm coordinated with the at least one event notice; and
a communication interface coupled with an external device for uploading the data from the management device to the external device.

7. The device of claim 6, wherein the data comprises sales data.

8. The device of claim 6, wherein the data comprises competition data.

9. The device of claim 6, wherein the activity management device is operatively coupled with the external device via a wireless communication.

10. The device of claim 6, wherein the activity management device is operatively coupled with the external device via a USB connection.

11. An activity management system comprising: a central processing unit and machine-readable storage medium;
machine-readable instructions encoded on the medium for executing instructions for receiving and storing data and inputting at least one event notice;
an alarm coordinated with the at least one event notice;
a communication interface coupled with an external device for uploading the data from the activity management system to the external device; and
a database remotely stored and populated by the data uploaded from the activity management system via the external device to the database.

12. The system of claim 11, wherein the communication interface interconnects the activity management system with the external device.

13. The system of claim 11, wherein the data comprises sales data.

14. The system of claim 11, wherein the data comprises competition data.

15. The system of claim 11, wherein the activity management system is operatively coupled with the external device via wireless communication.

16. The system of claim 11, wherein the activity management system is operatively coupled with the external device via a USB connection.

17. The system of claim 11, wherein the communication interface further comprising a network server, the network server interconnecting and in communication with the central processing unit and the storage medium, and the communication interface interconnecting and in communication with the external device and the storage medium.

18. The system of claim 11, wherein the communication interface being in wireless communication with the central processing unit, the storage medium, and the external device.

19. The system of claim 17, wherein the external device uploads an information and a data onto the network server, the external device populating the storage medium with the information and the data for storage, recall and analysis.

20. The system of claim 17, wherein the network server comprises a password module in order to protect access to the network server.

21. The system of claim 20, wherein the password module controls a password manager screen which enables a user to share an information and/or a data, and to import and download images or videos from other websites and services.

22. The system of claim 21, wherein the manager screen comprises share/import/download options.

23. The system of claim 22, wherein the share/import/download options include sharing information and/or data, importing and downloading a material from a social network site.

24. One or more machine-readable executable instructions method for performing sales activity management for monitoring, managing, and/or tracking a plurality of sales activities comprising a sales cycle, the method comprising:
receiving and storing data and inputting at least one event notice, an alarm coordinated with the at least one event notice;
inputting and storing the plurality of sales activities;
providing ratios and percentages calculated from particular combinations of sales activities; and
retrieving and viewing the calculated ratios and percentages, and a communication interface operatively coupled with an external device for uploading the data from the management device to the external device.

25. The method of claim 24, wherein the data comprises sales data.

26. The method of claim 24, wherein the data comprises competition data.

27. The method of claim 24, wherein one or more machines are operatively coupled with one or more external devices via wireless communication, the one or more devices capable of performing the machine-executable instructions and transmitting information therebetween.

28. The method of claim 24, wherein one or more machines are operatively coupled with one or more external devices via USB connection, the one or more devices capable of performing the machine-executable instructions and transmitting information therebetween.

29. One or more machine-readable executable instructions remotely accessible through a web-based protocol for performing sales activity management for monitoring, managing, and/or tracking a plurality of sales activities comprising a sales cycle, the method comprising:
accessing the remote web-based method through a user interface requiring at least a user name and a password associated with the user name;
receiving and storing data and inputting at least one event notice, an alarm coordinated with the at least one event notice;
inputting and storing the plurality of sales activities;
providing ratios and percentages calculated from particular combinations of sales activities;
retrieving and viewing the calculated ratios and percentages, and a communication interface operatively coupled with an external device for uploading the data from the management device to the external device; and
uploading at least one document template into a dedicated library for storing and retrieving the at least one document.
